(19) United States
(12) Patent Application Publication
(10) Pub. No.: US 2026/0368680 A1
(43) Pub. Date: Nov. 19, 2026

(54) Methods and algorithms for organizational alignment and improving employee performance

(71) Applicants: Anya Singh, San Ramon, CA (US); Anishka Singh, San Ramon, CA (US)

(72) Inventors: Anya Singh, San Ramon, CA (US); Anishka Singh, San Ramon, CA (US)

(21) Appl. No.: 19/206,474

(22) Filed: May 13, 2025

(51) Int. Cl. G06Q 10/0639

(52) U.S. Cl. CPC G06Q 10/06398; G06Q 10/06393

(57) ABSTRACT

A process and algorithms to compute an organization's alignment and employee's performance awards based on organizational goals are provided. Existing industry processes use qualitative and quantitative criteria to define employee's goals but the performance awards are not computed proportionally based on employees' performance but rather on manager's subjective evaluation of each employee's performance.

### FIELD

This application describes processes and algorithms for an organization to define strategic goals and to align its employees with those goals. It also provides techniques to evaluate and distribute performance awards according to employee performance as measured against the goals, and to assess organization's overall success in meeting those goals.

### BACKGROUND OF THE INVENTION

Many organizations conduct annual planning sessions and define goals and priorities for the upcoming year. Organizations then describe these goals to its employees with the aim to align employees with described goals and create incentives for employees to achieve via raises, bonuses, promotions and other incentives based on achievement of the goals. For instance, if an organization prioritizes improving product or service quality for a given year, it may design incentives that directly support this objective.

Current methods of employee's performance evaluation and performance awards rely on qualitative feedback and analysis, which can be influenced by biases and incomplete information. Such limitations can lead to misalignment between employees' behaviours and organization's goals.

Furthermore, organizations have poor tools to quantify and evaluate how aligned are managers' decisions on raises to organization's priorities. These limitations cause misalignment between an organization's set priorities and various incentives awarded to employees.

### SUMMARY OF THE INVENTION

Employees' behavior can be altered only if goals are clearly explained to them, including their relative importance of various goals and incentives awarded in proportion to employees' performance measured against goals. And clear feedback should be provided to employees on their actions.

This application introduces processes to help organizations clearly define their goals and prioritize them effectively. This application then enables managers to gather both quantitative and qualitative feedback on employees' contributions toward these goals and distribute incentives proportionally based on performance. Additionally, managers can use these methods to provide clear, actionable feedback to employees, explaining the rationale behind award distribution.

This application also provides a system for organizations to evaluate how different managers are performing against organizations goals.

### BRIEF DESCRIPTION OF DRAWINGS

FIG. 1: Describes the organization goals used for studying how managers allocate performance awards to employees without the application.

FIG. 2: Describes the results of a survey asking 2 managers to allocate performance awards to 10 employees based on different results of their scores.

FIG. 3: Describes the steps involved in generating performance awards for employees and managers.

FIG. 4: Compares results of survey and awards generated by the algorithm.

FIG. 5: Describes an organization's multiple goals and the scores given to those goals.

FIG. 6: Compares results of survey and the computed awards generated by the algorithm across multiple goals.

FIG. 7: Describes an organization's multiple goals and the scores given to those goals, the scores are then used for computing manager's evaluations as illustrated in FIG. 8.

FIG. 8: Compares results of manager's performance scores computed by averaging individual employees' performance scores and managers' own survey scores.

### DETAILED DESCRIPTION OF THE INVENTION

A study was conducted to understand how seasoned managers allocate incentive awards to employees and how those awards are influenced by organizational goals for the year. The data presented in this application is synthesized for the purpose of the study.

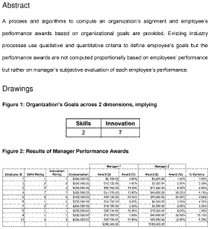

Study focused on an organization that defined 2 goals (FIG. 1), namely Skills and Innovation. Skills goal was meant to evaluate how skilled an employee is, while Innovation goal was added to capture how innovative an employee is. The organization wanted to prioritize innovation over employee skills and organization's executives gave an importance score of 2 to Skills and 7 to Innovation out of a possible maximum of 10 each. A higher score implied that the organization wanted more incentives for employees to focus on innovation for the upcoming year.

Employees were given a score for each goal, namely, Skill and Innovation. A base salary of $200,000 was defined for each employee. Managers were given a total budget of $200,000 (10% of existing budget) to award to employees based on their scores on Skills and Innovation. Each manager gave an award (FIG. 2) but the awards show high variance for the same score for employees, reflecting manager biases. When asked to explain the awards, managers could not quantify the proportionality of awards amongst employees. In an organization, such variance amongst managers can cause a difference in incentives awarded to employees across different managers, even if their performance is the same. Over multiple years, these variances can cause a wide difference in cumulative total of awards given to employees, even though their performance may have been similar. This application attempts to make incentives and awards more proportional and consistent across the whole organization.

In addition, when presented with 5 competing goals, managers were overwhelmed and could not distribute awards in proportion, managers just focused on top or bottom score for each employee instead.

To improve alignment between organization's goals and employee awards, this application proposes following steps:
1. Defining organization's goals: First step in our process is to clearly identify organizations' goals. An organization could have multiple goals to focus on but the executive management should narrow down and agree on top priorities for their organization. Large organizations could define different goals for different divisions, our process will work the same way for each division. To be effective organizations should limit the number of goals to less than or equal to 5. This step is generally done during annual planning in organizations.
   Let the organization's goals be defined as G₁, G₂ . . . Gₙ.
2. Score organization's goals: A survey of executives is conducted by asking them to score on a scale of 1-10 (1—Lowest, 10—Highest) their corporate goals for the upcoming period. Each executive is allowed to assign a maximum score of 5*n where n is the number of goals identified in step 1.
   An average of the scores is then taken to define the corporate goals and their scores.
   Once goals have been agreed upon they should be clearly publicized and explained to all the employees. Executives should explain what each goal means and why the goals were set with certain scores.
   Let the scores corresponding to goals G₁, G₂ . . . Gₙ be S₁, S₂, . . . Sₙ. such that

Σ^{i=1 . . . n}S<=5*n
The above constraint ensures that executives do not just score each goal as 10.
3. Collect employees' scores against organization's goals: Next step in the process is to conduct surveys asking an employee's co-workers and managers to rate employees' performance on a scale of 1-10.
   Managers should define how their teams can meet organizational goals. For e.g. for a goal of innovation, executives or managers can give the following criteria:

| Score | Examples |
|---|---|
| 1-2 | No major impact to innovation, employees have made |
| | no measurable impact to organizational goals. |
| | For e.g. add a unit test for each code change. |
| 2-4 | Employees have made small tweaks to existing |
| | products and features and have had minimal impact on |
| | organization. |
| | For e.g. improved existing code deployment pipeline to |
| | improve code deployment times by 10%. |
| 5-7 | Employees have displayed significant impact on |
| | organization by improving existing processes or |
| | products. The impact has resulted in direct benefit to |
| | customers and revenue. |
| | For e.g. added a button that shortens the customer |
| | workflows. |
| 8-10 | Employees have had a major impact on the |
| | organization's goal of innovation, either by changing |
| | existing processes to make them more efficient, |
| | innovating new product ideas or improving existing |
| | products by introducing new features. |
| | For e.g. filed for a new patent that gives competitive |
| | advantage to the organization. |

The survey participants' responses are then averaged out to give a composite score for each employee against prioritized organization's goals. This process recommends at least 5 survey participants for each employee.
Let the scores for an employee across G₁, G₂ . . . Gₙ be S₁, S₂, . . . Sₙ.
To prevent employees from influencing the scores following various steps are added to the survey:
   a. For each employee's survey there should be at least 5 co-workers chosen by managers. These have worked closely with the employee and should have intimate knowledge of the employee's work.
   b. Survey respondents should add qualitative feedback explaining the reasons for their scores.
   c. Managers should review each feedback and ensure that the scores match qualitative feedback provided.
4. Compute organization and employees' performance vectors: Next step in the process is to compute a performance score for each employee based on the results of surveys.
   a. First step is to compute performance vectors for the organization.
      Performance vector for the organization is computed as

V(O)=[S₁,S₂, . . . ,Sₙ]
b. Next step is to compute performance vectors for each employee.

v(e)=[S₁,S₂, . . . ,Sₙ]
5. Compute performance scores for each employee: Performance scores for each employee are then computed using the following algorithm

p(e)=dot product between V(O),v(e)
where, p (e) is the performance score for an employee
6. Compute performance awards for each employee: The performance award for each employee is then computed

min(award)<=a(e₁)=B*p(e)/Σ^{i=1 . . . n}p(eᵢ)<=max(award)
where, B is the total performance budget assigned to the manager to distribute amongst employees
p(e) is the performance score for an employee
Σ^{i=1 . . . n} p(eᵢ) is the sum of performance score for all employees reporting to the manager
min (award) and max (award) are minimum and maximum awards that are awarded to an employee. These limits are set by the organization as a percentage of existing compensation. These limits ensure that the performance awards are not skewed.
The performance scores and awards should be explained to each employee so that they can understand the criteria for their awards.
7. Compute performance scores for each manager: Next step is to score the performance of each manager's team against organization goals. Each manager conducts own survey.
   Each manager's score is an average of scores for each of the employees reporting to the manager plus manager's own survey responses.

V(m)=average(Σv(e)/n+v(m))

P(m)=dot product between V(O),V(m)
Where V (m) is the final vector of score scores for the manager
v(e) is the vector of scores scores for each employee reporting to manager
v(m) is the vector of scores scores for manager computed by conducting survey from manager's peers
n is the number of employees reporting to the manager
P(m) is the performance score for the manager
Award for the manager is computed using managers performance scores.
This process is rolled up so that performance scores for each manager is computed based on scores of managers reporting to them. Comparisons among various managers can indicate which teams are aligned well with the organization's goals and which are not. FIG. 6 shows an example of such evaluations, managers with highest performance scores have the best alignment with organizational goals.
8. Compute performance scores for the whole organization: The above process is continued till it reaches the top level of the organization or the department. The top level scores indicate how well the total organization is aligned with its goals.
9. Evaluate organization's overall alignment: Organization can assess which managers are aligned and which are not, then provide feedback to its managers and executives.
   Using above steps the performance awards for 10 employees, with a total award budget of $200,000, is recomputed and illustrated in FIG. 4. Following observations are provided to prove that computed incentives are proportional to the organizational goals.
1. Employee ID #4 and #5 scored high across both dimensions but Manager gave an award of 15% to employee #4 and 20% to employee #5. Manager 2's allocations were 20% and 25% whereas computed awards were at 18.92% and 21.62% for the same employees. The computed awards are fairer and consistent.
2. Employe ID #1 received the lowest score on both goals, Manager 1 gave a raise of 2.85% whereas Manager 2 gave a raise of 1% to the same employee. Computed award was 2.7%.
3. Employee Id #8 received scores of (1,7) where as Employee ID #9 received scores of (7,1). Manager 1 gave an award of 10% and 7.5% to Employee ID #8 and #9. Manager 2 identified the mis-alignment with the organization's goals and gave an award of 9% and 20%. Computed awards were 6.31% and 15.32% respectively, honoring the needed skew towards organization's goals.

What is claimed is:

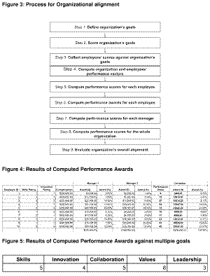

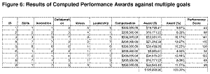

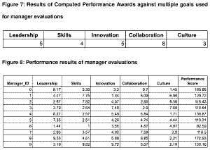

1. A method for evaluating employee performance, comprising: defining organizational goals; assigning relative scores to said goals based on predefined criteria; measuring employee performance against the assigned scores; and awarding performance evaluations based on the measured results, as illustrated in FIG. 3.

2. As part of method defined in claim 1, process to assign quantitative scores to organizational goals by conducting a survey of executives.

3. As part of the method defined in claim 1, process to assign scores against organizational goals for each employee by conducting surveys with the employee's co-workers.

4. As part of the method defined in claim 1, algorithm to compute performance scores for each employee based on that employee's performance score, against organizational goals.

5. As part of the method defined in claim 1, algorithm to compute incentive awards for each employee based on computed performance scores.

6. As part of method defined in claim 1, algorithm to compute performance scores for each manager based on computed performance scores for each reporting employee manager's own survey results.

7. As part of method defined in claim 1, process to compute organization's overall success in meeting stated goals.
